(19) United States
(12) Patent Application Publication
(10) Pub. No.: US 2015/0002973 A1
(43) Pub. Date: Jan. 1, 2015

(54) OVERHEAT PROTECTION CIRCUIT AND OVERHEAT PROTECTION METHOD

(71) Applicant: Yazaki Corporation, Tokyo (JP)

(72) Inventors: Takeshi Yamashita, Shizuoka (JP); Yasutaka Hanaoka, Shizuoka (JP)

(21) Appl. No.: 14/488,887

(22) Filed: Sep. 17, 2014

Related U.S. Application Data
(63) Continuation of application No. PCT/JP2013/060264, filed on Mar. 28, 2013.

(30) Foreign Application Priority Data
Apr. 5, 2012 (JP) 2012-086322

(51) Int. Cl. H02H 5/04

(52) U.S. Cl. CPC H02H 5/047
USPC 361/103

(57) ABSTRACT

An overheat protection circuit for protecting a switching element from abnormal overheat is provided, the switching element configured to supply electric power from a power source to a side of a load, including an interruption function part configured to detect a layer short inside the switching element and configured to detect temperature of the switching element. The interruption function part is configured to interrupt the electric power supplied from the power source to the side of the load at an input part of the switching element, when detecting the layer short and detecting that the temperature exceeds a predetermined value, and configured not to interrupt the electric power supplied from the power source to the side of the load at an input part of the switching element, when detecting the layer short and detecting that the temperature does not exceed a predetermined value.

### CROSS REFERENCE TO RELATED APPLICATIONS

This application is a continuation of PCT application No. PCT/JP13/060264, which was filed on Mar. 28, 2013 based on Japanese Patent Application (No. 2012-086322) filed on Apr. 5, 2012, the contents of which are incorporated herein by reference.

### BACKGROUND OF THE INVENTION

1. Field of the Invention

The present invention relates to an overheat protection circuit and an overheat protection method suitable for protecting a switching element from abnormal overheat.

2. Description of the Related Art

Traditionally, switching elements such as FETs (Field Effect Transistors) are often used in place of a mechanical relay in a device which supplies electric power from a power source to the side of a load.

As a measure to avoid the abnormal overheat generated in the FET, in a circuit composition in which electric power is supplied from a power source to the side of a load through the FET, and a fuse is provided in the upstream side of the FET, it is typical that the fuse melts to interrupt an over current, for example, when the over current flows.

However, when the FET, which is a semiconductor to replace a traditional mechanical relay, is used, the abnormal overheat may be generated by failures resulted from some causes other than the over current. Such a phenomenon may similarly occur even if the FET has an overheat interruption function.

To prevent such an abnormal overheat, in a patent literature 1, an overheat protection circuit is proposed in which the positive terminal of a battery is connected to the source terminal of a p-channel FET, the power source terminal of a power amplifier is connected to the drain terminal of the p-channel FET, and a detection output of a temperature switch IC is connected to the gate terminal of the p-channel FET. When the temperature of the power amplifier exceeds a specified value, the output from the temperature switch IC becomes HIGH and the p-channel FET is turned to an OFF state so that the power supply from the battery to the power amplifier is interrupted.

### CITATION LIST

### Patent Literature

[PTL 1] Japan Patent Publication No. 2008-135820 A

In the above overheat protection circuit of the patent document 1, since when the temperature of the power amplifier exceeds the specified value, the p-channel FET is turned to an OFF state according to the output from the temperature switch IC, the abnormal overheat of the power amplifier is avoided. In this case, because the p-channel FET is turned to an OFF state, the abnormal overheat of the p-channel FET is also avoided.

However, in such an overheat protection circuit, a layer short (interlayer short circuit) may occur between the gate terminal and the source terminal or between the drain terminal and the source terminal when the gate oxide film of the p-channel FET is damaged, for example, because of the outbreak of a surge.

Because the p-channel FET is not turned to an OFF state when such a layer short (interlayer short circuit) occurs, there is a problem that even if the specified value of the temperature switch IC is exceeded because of the overheat caused by the layer short (interlayer short circuit), the abnormal overheat of the p-channel FET continues, and the p-channel FET is damaged.

### SUMMARY OF THE INVENTION

The present invention is made in view of these situations, and the object of the present invention is to provide an overheat protection circuit and an overheat protection method which can surely prevent a switching element from abnormal overheat.

According to one aspect of the present invention, there is provided an overheat protection circuit for protecting a switching element from abnormal overheat, the switching element configured to supply electric power from a power source to a side of a load, comprising

an interruption function part configured to detect a layer short inside the switching element and configured to detect temperature of the switching element, wherein

the interruption function part is configured to interrupt the electric power supplied from the power source to the side of the load at an input part of the switching element, when detecting the layer short and detecting that the temperature exceeds a predetermined value, and configured not to interrupt the electric power supplied from the power source to the side of the load at an input part of the switching element, when detecting the layer short and detecting that the temperature does not exceed a predetermined value.

According to another aspect of the present invention, there is provided an overheat protection method for protecting a switching element from abnormal overheat, the switching element configured to supply electric power from a power source to a side of a load, wherein

an interruption function part, which has a function of detecting a layer short inside the switching element and a function of detecting temperature of the switching element, is provided,

when the layer short is detected by the interruption function part, and the detected temperature exceeds a specified value, the electric power which is supplied from the power source to the side of the load is interrupted at an input part of the switching element, and

when the layer short is detected by the interruption function part, and the detected temperature does not exceed a specified value, the electric power which is supplied from the power source to the side of the load is not interrupted at an input part of the switching element.

In the overheat protection circuit and the overheat protection method of the present invention, when a layer short is detected by the interruption function part which has the function of detecting the layer short inside the switching element and the function of detecting the temperature of the switching element, and the detected temperature exceeds the specified value, the electric power which is supplied from the power source to the side of the load is interrupted at the input part of the switching element.

According to the overheat protection circuit and the overheat protection method of the present invention, since when a layer short is detected by the interruption function part which has the function of detecting the layer short inside the switching element and the function of detecting the temperature of the switching element, and the detected temperature exceeds the specified value, the electric power which is supplied from the power source to the side of the load is interrupted at the input part of the switching element, abnormal overheat at the side of the load can be surely prevented.

### BRIEF DESCRIPTION OF THE DRAWINGS

FIG. 1 is a view showing one embodiment of the overheat protection circuit of the present invention.

FIG. 2 is a view showing the overheat protection circuit of FIG. 1 in detail.

FIG. 3 is a view showing the overheat protection circuit of FIG. 1 in detail.

### DETAILED DESCRIPTION OF THE EXEMPLARY EMBODIMENTS

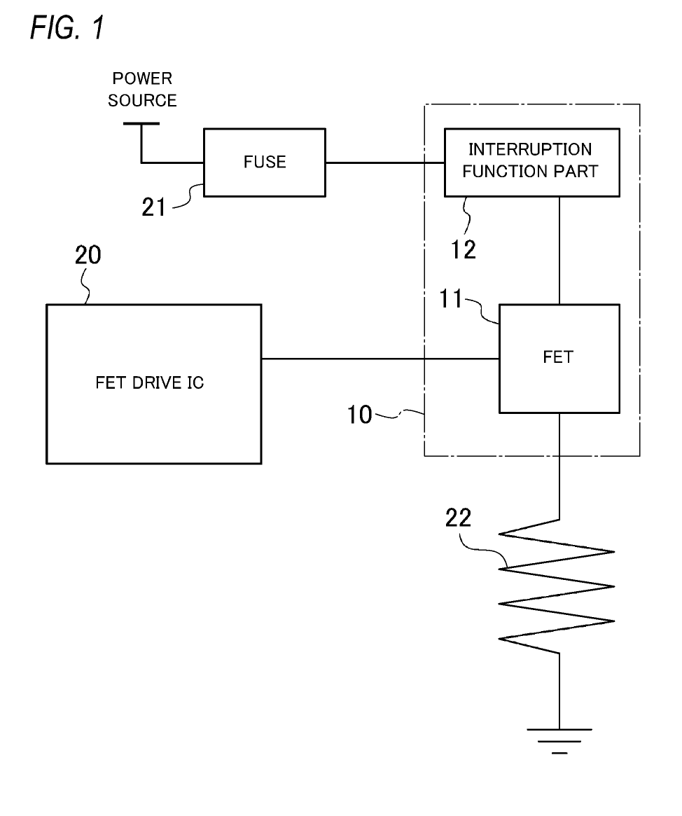

The embodiment of the overheat protection circuit of the present invention is described in detail with reference to FIGS. 1 to 3 as follows. First, as shown in FIG. 1, the overheat protection circuit includes an interruption function part 12 which is arranged near an FET (Field Effect Transistor) 11 which is a switching element mounted on a board 10.

In the figure, a reference numeral 20 is an FET drive IC which switches ON/OFF the FET 11, a reference numeral 21 is a fuse which interrupts the electric power from a power source when a current above a specified value flows, and a reference numeral 22 shows a load resistor. An MOSFET (Metal Oxide Semiconductor Field Effect Transistor) or a C-MOSFET (Complementary MOSFET) can be used as the FET 11. Either a P channel type or an N channel type can be used for both of the MOSFET and the C-MOSFET.

FIG. 1 shows a connecting manner in which the fuse 21, the FET 11 which is loaded on the board 10 and the interruption function part 12 are provided between the power source and the load resistor 22, and the FET 11 is switched ON/OFF by the FET drive IC 20.

The interruption function part 12, as will be described below, has functions of detecting a layer short (interlayer short circuit) current in the FET 11, detecting the temperature of the FET 11, and interrupting the electric power which is supplied from the power source to the side of the load resistor 22 at the input part of the FET 11.

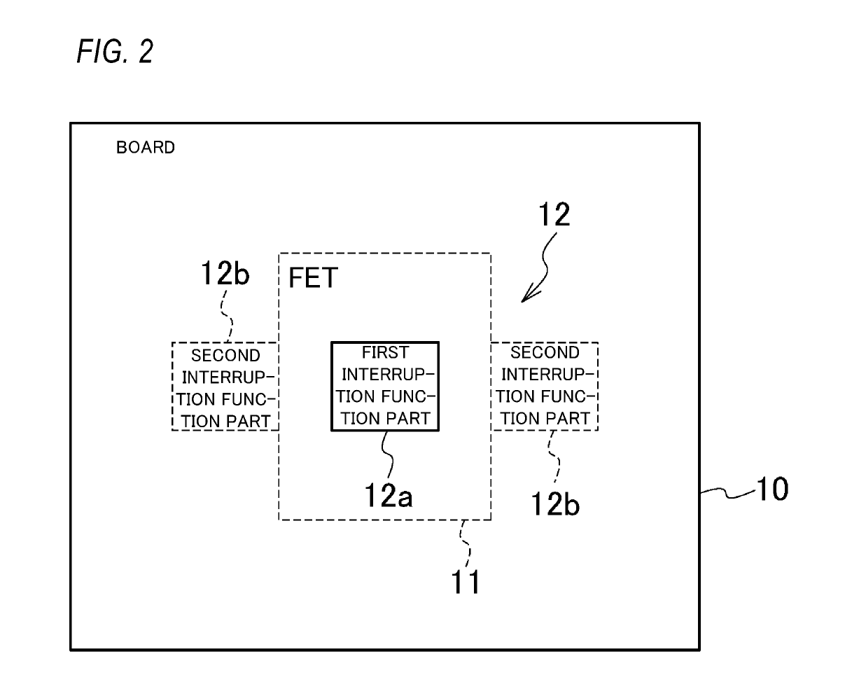

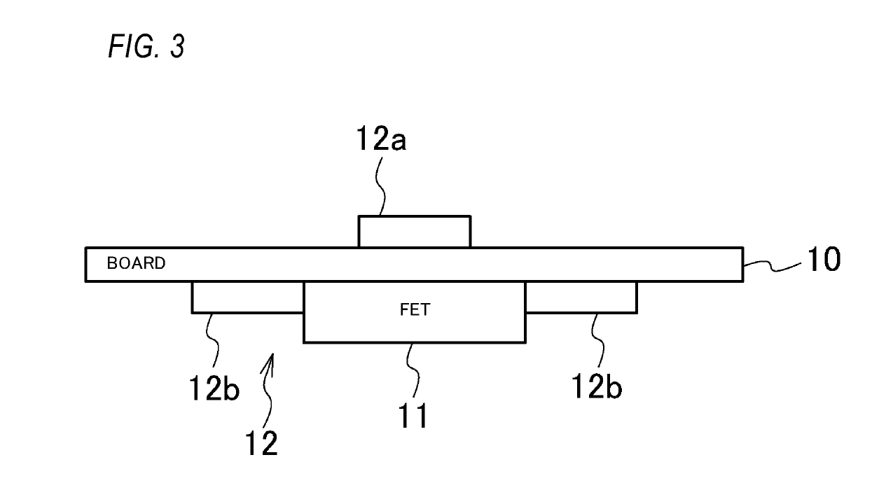

That is, as shown in FIGS. 2 and 3, the interruption function part 12 is loaded on the board 10 with the FET 11. The interruption function part 12 at least has a first interruption function part 12a which detects the layer short (interlayer short circuit) current in the FET 11, and a second interruption function part 12b which detects the temperature of the FET 11.

The first interruption function part 12a is provided on the surface opposite to the mounting surface of the board 10, and is in a position right opposite to the FET 11. The second interruption function part 12b is provided on the mounting surface of the board 10, and is in a position close to the FET 11.

The first interruption function part 12a detects the layer short (interlayer short circuit) current (for example, the increase of a gate current) in the FET 11. The second interruption function part 12b detects the temperature of the FET 11. When a layer short (interlayer short circuit) current is detected by the first interruption function part 12a, if the temperature of the FET 11 which is detected by the second interruption function part 12b does not exceed the specified value, the interruption function part 12 will not interrupt the electric power from the power source to the side of the load resistor 22, but if the temperature of the FET 11 which is detected by the second interruption function part 12b exceeds the specified value, the interruption function part 12 interrupts the electric power from the power source to the side of the load resistor 22 at the input part of the FET 11.

Although in this case, the first interruption function part 12a is provided on the surface opposite to the mounting surface of the board 10, and the second interruption function part 12b is provided on the mounting surface, it is also possible to reversely provide the first interruption function part 12a and the second interruption function part 12b. The second interruption function part 12b is not limited to the arrangement shown in FIGS. 2 and 3, and may be provided in a place which is near the FET 11 and where the temperature of the FET 11 can be detected. The first interruption function part 12a is also not limited to the arrangement as shown in FIGS. 2 and 3.

It is preferred for the first interruption function part 12a and the second interruption function part 12b to have such a construction that a layer short (interlayer short circuit) will not occur. That is, it is preferred for the internal constructions of the first interruption function part 12a and the second interruption function part 12b to have enough voltage resistance and insulation for a surge between the signal lines of the first interruption function part 12a and the second interruption function part 12b.

With such a construction, when a layer short (interlayer short circuit) current is generated in the FET 11 because of the surge, the layer short (interlayer short circuit) current is detected by the first interruption function part 12a of the interruption function part 12. The temperature of the FET 11 is detected by the second interruption function part 12b.

At this time, when the layer short (interlayer short circuit) is detected by the first interruption function part 12a, if the temperature of the FET 11 which is detected by the second interruption function part 12b does not exceed the specified value, the interruption function part 12 will not interrupt the electric power from the power source to the side of the load resistor 22. On the other hand, if the temperature of the FET 11 which is detected by the second interruption function part 12b exceeds the specified value, the interruption function part 12 will interrupt the electric power from the power source to the side of the load resistor 22 at the input part of the FET 11.

When an over current is generated, the above-mentioned fuse 21 melts so that the electric power from the power source to the side of the load resistor 22 is interrupted at the upstream side of the FET 11.

Thus, in this embodiment, when a layer short (interlayer short circuit) current is generated in the FET 11, and the layer short (interlayer short circuit) current is detected by the first interruption function part 12a, if the temperature of the FET 11 which is detected by the second interruption function part 12b does not exceed the specified value, the interruption function part 12 will not interrupt the electric power from the power source to the side of the load resistor 22, and if the temperature of the FET 11 which is detected by the second interruption function part 12b exceeds the specified value, the interruption function part 12 will interrupt the electric power from the power source to the side of the load resistor 22 at the input part of the FET 11.

Thereby, the abnormal overheat of the FET 11 caused by the layer short (interlayer short circuit) current can be surely prevented. Because continuous abnormal overheat of the FET 11 is avoided, the FET 11 can be surely prevented from being damaged.

In this embodiment, it is described that if the temperature of the FET 11 which is detected by the second interruption function part 12b does not exceed the specified value, the interruption function part 12 will not interrupt the electric power from the power source to the side of the load resistor 22, and if the temperature of the FET 11 which is detected by the second interruption function part 12b exceeds the specified value, the interruption function part 12 will interrupt the electric power from the power source to the side of the load resistor 22 at the input part of the FET 11, but the invention is not limited to this. The electric power may be interrupted at the input part of the FET 11 by the interruption function part 12 when a layer short (interlayer short circuit) current is detected by the first interruption function part 12a.

The electric power from the power source to the side of the load resistor 22 may be interrupted at the input part of the FET 11 when the temperature of the FET 11 detected by the second interruption function part 12b exceeds the specified value even if an layer short (interlayer short circuit) current is not detected by the first interruption function part 12a. In this case, the abnormal overheat of the FET 11 generated due to causes other than a layer short (interlayer short circuit) can be avoided.

It is apparent that various modifications can be made in the invention within a scope not deviating from the gist of the invention.

The invention is applicable to an overall device in which a circuit which supplies electric power from a power source to the side of a load through a switching element is loaded.

What is claimed is:

1. An overheat protection circuit for protecting a switching element from abnormal overheat, the switching element configured to supply electric power from a power source to a side of a load, comprising
an interruption function part configured to detect a layer short inside the switching element and configured to detect temperature of the switching element, wherein
the interruption function part is configured to interrupt the electric power supplied from the power source to the side of the load at an input part of the switching element, when detecting the layer short and detecting that the temperature exceeds a predetermined value, and configured not to interrupt the electric power supplied from the power source to the side of the load at an input part of the switching element, when detecting the layer short and detecting that the temperature does not exceed a predetermined value.

2. An overheat protection method for protecting a switching element from abnormal overheat, the switching element configured to supply electric power from a power source to a side of a load, wherein
an interruption function part, which has a function of detecting a layer short inside the switching element and a function of detecting temperature of the switching element, is provided,
when the layer short is detected by the interruption function part, and the detected temperature exceeds a specified value, the electric power which is supplied from the power source to the side of the load is interrupted at an input part of the switching element, and
when the layer short is detected by the interruption function part, and the detected temperature does not exceed a specified value, the electric power which is supplied from the power source to the side of the load is not interrupted at an input part of the switching element.
